(19) United States
(12) Patent Application Publication
(10) Pub. No.: US 2004/0117854 A1
(43) Pub. Date: Jun. 17, 2004

(54) Method for processing moving pictures responding to user's action

(76) Inventor: Hyun-Gi An, Kyunggi-Do (KR)

Correspondence Address: CANTOR COLBURN, LLP, 55 GRIFFIN ROAD SOUTH, BLOOMFIELD, CT, 06002

(21) Appl. No.: 10/472,682

(22) PCT Filed: Mar. 25, 2002
(86) PCT No.: PCT/KR02/00511

(30) Foreign Application Priority Data
Mar. 26, 2001 (KR) 2001-15799
Mar. 18, 2002 (KR) 2002-14568

(51) Int. Cl. H04N 7/16; H04N 5/445; H04N 11/00; H04N 7/00; H04N 5/45

(52) U.S. Cl. 725/135; 348/563; 348/460; 348/461; 725/136; 348/565

(57) ABSTRACT

A method for processing moving pictures in response to the user's actions. A variable moving picture creation module, variation moving picture reproduction module and variable moving picture transmission module are employed in the method. The variable moving picture creation module creates a variable moving picture to be created in response to the user's actions. The variable moving picture reproduction module reproduces the variable moving picture so that the variable moving picture is realistically reproduced. The variable moving picture transmission module transmits the variable moving picture to a receiver's E-mail server, personal data assistant (PDA), mobile communication terminal, computer or etc. over the Internet so that the variable moving picture is reproduced in response to the actions of the user being a receiver. Accordingly, an idea and intention of a transmitter user can be implemented in an enjoyable and interesting manner.

### TECHNICAL FIELD

The present invention relates to a method for processing moving pictures in response to a user's actions, and more particularly to a technique for processing moving pictures using the Internet in response to a user's actions, which creates the moving pictures, stores the created moving pictures in a server and transmits the created moving pictures to a client computer.

### BACKGROUND ART

As information communication techniques are developed, large-capacity moving pictures have been provided through the Internet by a variety of multimedia techniques, arousing user's interest in the large-capacity moving pictures.

Currently, various competing methods for creation, transmission and reproduction of data having a multimedia element are being developed.

A moving picture captured by moving picture capturing means is compressed through conventional moving picture related techniques. The compressed moving picture is stored in a server. If the compressed moving picture is transmitted through a streaming or downloading procedure in response to a client-computer's request, moving picture reproduction software in the client computer decompresses the compressed moving picture and reproduces the moving picture so that moving picture services can be provided to the user.

The conventional moving picture related techniques are slightly different according to a compression, transmission, reproduction or moving picture provision way. However, where moving pictures are reproduced by the conventional moving picture related techniques, there is a disadvantage in that the moving pictures are reproduced by the same reproduction method irrespectively of a user's actions, which uses the moving picture services.

Meanwhile, a story of a digital movie or novel in an Internet environment can be divided into a plurality of stages so that its situation is developed stage by stage or characters appearing in the story are changed stage by stage. Therefore, a story framework or end of the digital movie or novel can be changed on the basis of the user's tastes.

The digital movie or novel story is divided into the stages on the basis of its progress or the convenience of a producer. If the digital movie or novel story reaches a particular stage, the user can change the story framework or end of the digital movie or novel by selecting a next stage. However, this is dependent on the user's selection rather than the user's action.

If particular contents relating to particular objects within a program to be broadcasted are selected by a user's manipulations in a system like an interactive television interactive with the user, different broadcast contents are provided to the user in response to the user's manipulations. Similarly, the broadcast contents are not dependent on the user's actions.

In various simulation systems, executable on computers to be used for simulating a real situation and educating persons, because the computers are programmed so that the various simulation systems can be variously operated on the basis of a user's behavior patterns by considering the user's actions in advance. Accordingly, the various simulation systems can implement various system operations in response to the user's actions.

An inventor of the present invention has developed a new concept of moving picture creation, transmission and reproduction techniques in which variety of moving pictures based on the user's behavior patterns is implanted into moving picture processing techniques. The new concept of moving picture creation, transmission and reproduction techniques can arouse interest of the users and provide entertainment to the users because different moving pictures can be reproduced in response to the user's actions.

### DISCLOSURE OF THE INVENTION

Therefore, the present invention has been made in view of the above problems, and it is an object of the present invention to provide a method for processing moving pictures in response to a user's actions, which can produce moving pictures in a realistic fashion by varying them in response to the user's actions.

It is another object of the present invention to provide a method for processing moving pictures in response to a user's actions, which can implement an idea and intention of a transmitting user in an enjoyable and interesting manner by transmitting variable moving pictures through an E-mail, personal data assistant (PDA), mobile communication terminal, computer or etc. and reproducing them in response to the actions of the user being a reception side.

In accordance with one aspect of the present invention, the above and other objects can be accomplished by the provision of a method for processing moving pictures in response to a user's actions, comprising the steps of: a) allowing a variable moving picture creation module to analyze predicted actions of a receiver receiving the moving pictures; b) allowing the variable moving picture creation module to create a plurality of partial moving pictures corresponding to types of the predicted actions analyzed at the step a); c) allowing the variable moving picture creation module to set reproduction information of respective partial moving pictures created at the step b); and d) allowing the variable moving picture creation module to create a variable moving picture by combining the partial moving pictures created at the step b) and the reproduction information created at the step c).

Preferably, the method may further comprise the step of: e) allowing the variable moving picture creation module to set predetermined content synthesis information with respect to the respective partial moving pictures created at the step b); and f) allowing the variable moving picture creation module to create another variable moving picture having the content synthesis information by further combining the content synthesis information into the variable moving picture.

In accordance with another aspect of the present invention, there is provided a method for processing moving pictures in response to a user's actions, comprising the steps of: a) allowing a variable moving picture transmission module to receive selection information of a variable moving picture from a client terminal connected to a network; b) allowing the variable moving picture transmission module to receive selection information of contents to be synthesized with respective partial moving pictures of the variable moving picture selected at the step a); c) allowing the variable moving picture transmission module to synthesize the partial moving pictures of the variable moving picture with the contents selected at the step b); and d) allowing the variable moving picture transmission module to transmit the partial moving pictures synthesized at the step c) or their access information to a receiver's terminal.

Preferably, the method may further comprise the step of: e) allowing the variable moving picture transmission module to receive variable moving picture receiver information.

In accordance with a further aspect of the present invention, there is provided a method for processing moving pictures in response to a user's actions, comprising the steps of: a) allowing a variable moving picture reproduction module to separate respective partial moving pictures and reproduction information from a variable moving picture; b) allowing the variable moving picture reproduction module to reproduce a first partial moving picture on the basis of the reproduction information separated at the step a); c) allowing the variable moving picture reproduction module to determine using the reproduction information whether there is a second partial moving picture corresponding to a predetermined action when the predetermined action has been taken by the user; and d) allowing the variable moving picture reproduction module to reproduce the second partial moving picture if there is the second partial moving picture corresponding to the predetermined action at the step c).

Preferably, the method may further comprise the step of: e) allowing the variable moving picture reproduction module to receive the variable moving picture or its access information from a server.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a flow chart explaining a variable moving picture creation module as employed in a method for processing moving pictures in response to a user's actions in accordance with the present invention;

FIG. 2 is a view showing a configuration block of a variable moving picture crated by the variable moving picture creation module in FIG. 1;

FIG. 3 shows a flow chart explaining a variable moving picture transmission module as employed in a method for processing moving pictures in response to a user's actions in accordance with the present invention; and

FIG. 4 shows a flow chart explaining a variable moving picture reproduction module as employed in a method for processing moving pictures in response to a user's actions in accordance with the present invention.

### BEST MODE FOR CARRYING OUT THE INVENTION

Preferred embodiments of the present invention will be described in detail with reference to the annexed drawings so that the present invention can be readily understood and reproduced.

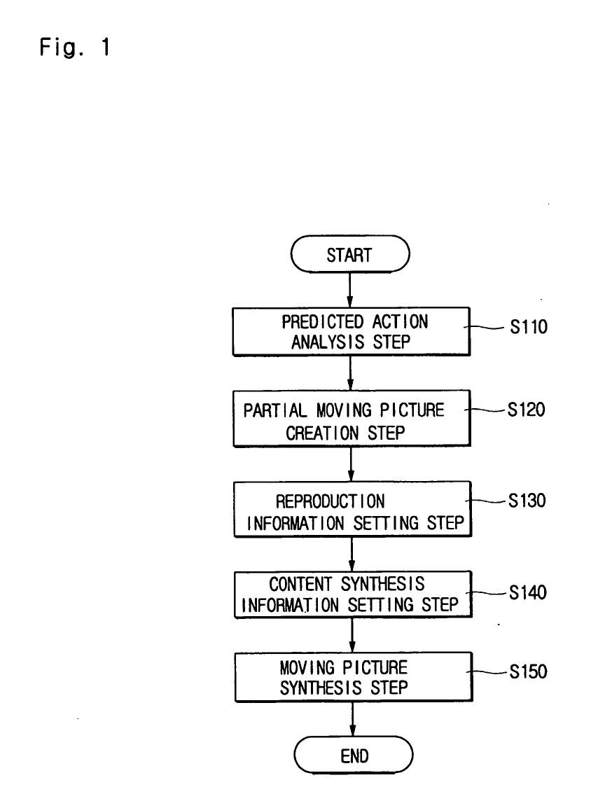

FIG. 1 shows a flow chart explaining a variable moving picture creation module as employed in a method for processing moving pictures in response to a user's actions in accordance with the present invention.

In this embodiment, the variable moving picture creation module performs step S110 of analyzing predicted actions of the user, step S120 of creating partial moving pictures, step S130 of setting reproduction information, step S140 of setting content synthesis information and step S150 of synthesizing the partial moving pictures.

The predicted actions of the user receiving the variable moving picture are analyzed at the above step S110. Types of the moving pictures are different according to the actions of the user reproducing the moving pictures and seeing and hearing them. The predicted actions taken by the user on the basis of each moving picture type can be analyzed at the above step S110.

At the above step S120, a plurality of partial moving pictures is created on the basis of types of the predicted actions analyzed at the above step S110. At the above step S120, the variable moving picture creation module creates the partial moving pictures corresponding to the user's actions on the basis of the types of the predicted actions. The respective partial moving pictures represent scenes divided to reflect the user's actions or the progress of a whole moving picture. Preferably, these partial moving pictures are real moving pictures captured by moving picture capturing means. However, the production of the real moving pictures reflecting the user's actions needs a larger number of process steps. Alternatively, a synthesized moving picture in which a part of the real moving pictures captured by the moving picture capturing means is synthesized with another real moving picture can be employed. Further, another synthesized moving picture in which the part of the real moving picture captured by the moving picture capturing means is synthesized with a graphic can be employed.

At the above step S130, reproduction information of respective partial moving pictures created at the above step S120 is set. At the above step S130, the respective partial moving pictures are selectively set in response to receiver's action inputs at the above step S130 so that the respective partial moving pictures are selectively reproduced. In other words, the reproduction information set at the above step S130 includes setting information representing which partial moving picture should be reproduced. Further, the reproduction information can include the setting information representing which partial moving picture should be first reproduced.

The above step S140 is an optional step. At the above step S140, content synthesis information is set so that the respective partial moving pictures created at the above step S120 are synthesized with predetermined contents. The respective partial moving pictures can be synthesized with various contents such as a partial sound, a partial scent, a partial text, a partial graphic, etc. When the partial moving pictures are reproduced, a particular sound, a particular scent, a particular message and a particular graphic can be simultaneously reproduced. The partial sound is sound data to be synthesized with the partial moving pictures. The partial scent is used as scent control information to be provided to a scent generator connected to a user computer. The partial scent is synthesized with the partial moving pictures. The partial text is a text to be synthesized with the partial moving pictures. The partial graphic is a graphic image to be synthesized with the partial moving pictures.

At the above step S150, the partial moving pictures created at the above step S120 and the reproduction information set at the above step S130 are combined to create the variable moving picture. The content synthesis information can be further combined with the partial moving picture and the reproduction information to create another variable moving picture.

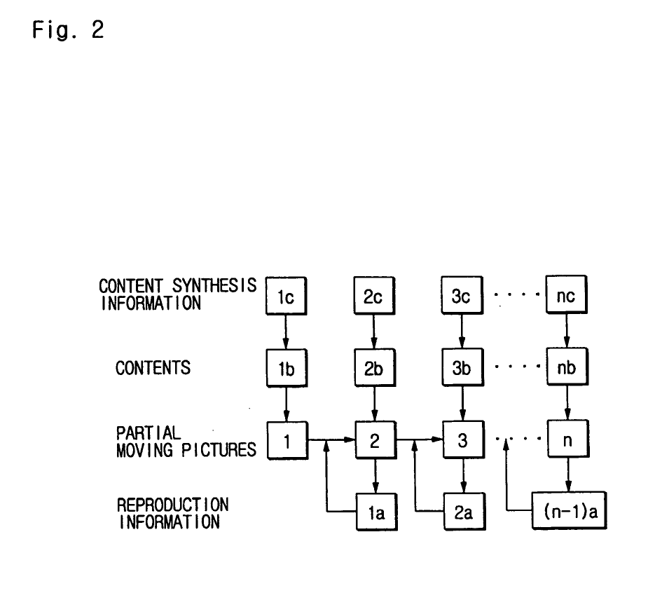

FIG. 2 is a view showing a configuration block of the variable moving picture crated by the variable moving picture creation module in FIG. 1.

As shown in FIG. 2, one variable moving picture includes a plurality of partial moving pictures (1, 2, 3 . . . n). The variable moving picture includes reproduction information having control information (1a, 2a, 3a . . . (n−1)a) for the partial moving pictures so that the respective partial moving pictures can be reproduced in response to the user's actions. Additionally, the variable moving picture includes a plurality of contents (1b, 2b, 3b . . . nb), which are synthesized with the respective partial moving pictures and reproduced. The variable moving picture further includes content synthesis information having control information (1c, 2c, 3c . . . nc) of the contents synthesized with the respective partial moving pictures.

The respective partial moving pictures, the reproduction information and the content synthesis information are combined at the above step S150 so that a final variable moving picture is acquired as shown in FIG. 2. The variable moving picture can be distributed on an on/off line to the user through a storage medium or communication medium such as a compact disk (CD) or etc. When the variable moving picture is reproduced, the respective moving pictures included in the variable moving picture are variably reproduced on the basis of the user's particular actions, whereby the user can feel the sense of the real from variable moving picture to be reproduced and arouse the interest of the user.

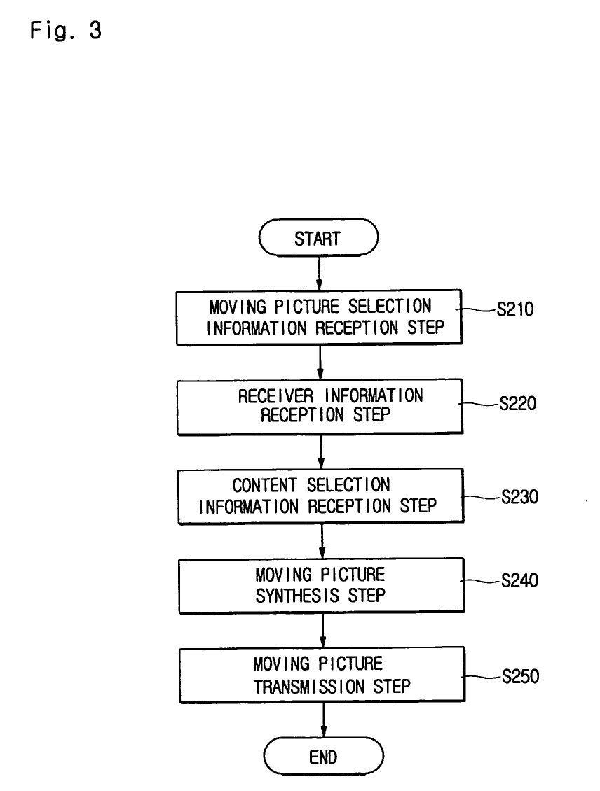

FIG. 3 shows a flow chart explaining a variable moving picture transmission module as employed in a method for processing moving pictures in response to a user's actions in accordance with the present invention.

In this embodiment, the variable moving picture transmission module performs step S210 of receiving variable moving picture selection information, step S220 of receiving variable moving picture receiver information, step S230 of receiving content selection information, step S240 of synthesizing the partial moving pictures and step S250 of transmitting the partial moving pictures.

The variable moving picture transmission module is provided on a server connected to a plurality of client computers and a network. Variable moving picture services are provided through a predetermined authentication procedure in response to a request of a client computer connected to the server.

The variable moving picture transmission module receives the variable moving picture selection information from the client computer connected to the network at the above step S210. In other words, the server providing the variable moving picture provides a variety of variable moving pictures. A client is connected to the server for providing the variable moving pictures after the predetermined authentication. The client selects a desired variable moving picture using its client computer. Then, the variable moving picture transmission module receives the variable moving picture selection information from the client computer at the above step S210.

The variable moving picture transmission module receives the variable moving picture receiver information from the client computer at the above step S220, which is an optional step.

The client connected to the server through the network can transmit the variable moving picture to its own computer or a third party. Where the client transmits to its own computer, the client can receive the variable moving picture through a downloading or streaming method using its own computer without inputting the variable moving picture receiver information and reproduce the variable moving picture. However, where the variable moving picture is transmitted to the third party, the third party receiving the variable moving picture needs the variable moving picture receiver information. At this time, the server receives the variable moving picture receiver information inputted from the client computer at the above S220.

The variable moving picture receiver information may be any one of the receiver's E-mail address, the receiver's PDA Internet protocol (IP) address, a mobile IP address of the receiver's mobile communication terminal and an IP address of the receiver's computer. Accordingly, the receiver being the third party receives the variable moving picture using its own E-mail, PDA, mobile communication terminal or computer and sees and hears the received variable moving picture by reproducing it.

The variable moving picture transmission module receives selection information of contents to be synthesized with the partial moving pictures of the selected variable moving picture. In other words, the client selects the contents to be synthesized with the partial moving pictures of the selected variable moving picture using its own computer, and the server receives the content selection information at the above step S230. Only the variable moving picture itself can be transmitted without being synthesized with the contents.

The contents include at least one of a partial sound, a partial scent, a partial text, a partial graphic, etc. When the partial moving pictures are reproduced, a particular sound, a particular scent, a particular message and a particular graphic along with a corresponding partial moving picture can be simultaneously reproduced.

At the above step S240, the variable moving picture transmission module synthesizes the partial moving pictures with the contents selected at the above step S230. In other words, a final variable moving picture to be transmitted is created by synthesizing the respective partial moving pictures of the variable moving picture selected by the client with the contents at the above S240.

At the above step S250, the variable moving picture transmission module transmits the partial moving pictures synthesized at the above step S240 or their access information to the receiver's terminal. In other words, the server transmits the variable moving picture selected by the client computer, the variable moving picture synthesized with the contents, or its access information using any one of the receiver's E-mail address, the receiver's PDA Internet protocol (IP) address, a mobile IP address of the receiver's mobile communication terminal and an IP address of the receiver's computer at the above step S250.

Accordingly, the server providing the variable moving picture services selects the variable moving picture. The server transmits the variable moving picture through an E-mail, personal data assistant (PDA), mobile communication terminal, computer or etc. so that the variable moving picture is reproduced in response to the actions of the user being a receiver. Accordingly, an idea and intention of a transmitting user can be implemented in an enjoyable and interesting manner.

When the variable moving picture is transmitted, the variable moving picture is compressed through a predetermined compression process and the compressed variable moving picture is transmitted. When the user desires to reproduce the variable moving picture, the user should decompress the compressed variable moving picture to reproduce the variable moving picture. Because compression and decompression techniques relating to the present invention are well known to those in the art and publicly used, the description of the compression and decompression is omitted.

Where the access information linked to the synthesized moving picture is transmitted to the receiver's terminal at step S250, the variable moving picture linked to the access information are transmitted from the server to the receiver's terminal in response to a request from the receiver's terminal. In other words, where a capacity size of the variable moving picture is greater, the access information rather than the variable moving picture itself is transmitted. If the user desires to reproduce the variable moving picture, the user accesses the server to receive the variable moving picture and reproduce the received variable moving picture, whereby unnecessary data transmission and therefore required time and costs can be reduced.

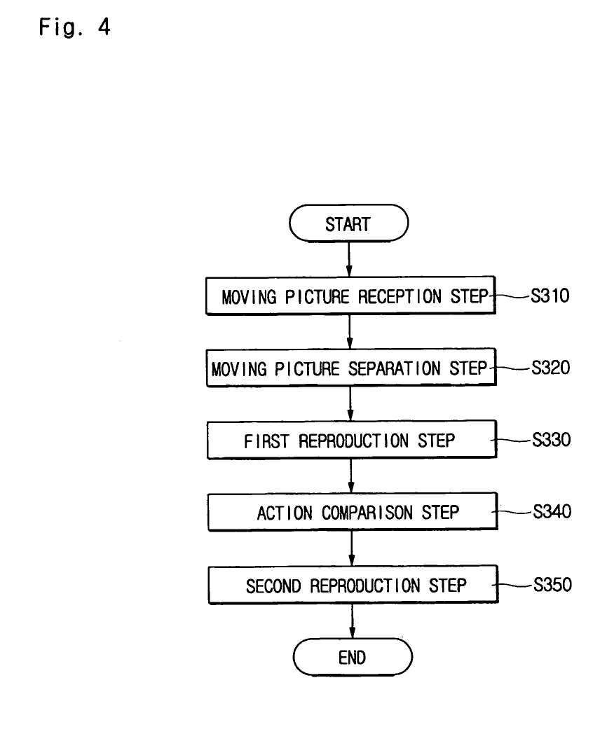

FIG. 4 shows a flow chart explaining a variable moving picture reproduction module as employed in a method for processing moving pictures in response to a user's actions in accordance with the present invention.

In this embodiment, the variable moving picture reproduction module performs step S310 of receiving the variable moving picture, step S320 of separating partial moving pictures, a first reproduction step S330, step S340 of comparing the user's actions and a second reproduction step S350. The variable moving picture reproduction module receives the variable moving picture or its access information at the above step S310.

In accordance with this embodiment, there is a way that the variable moving picture reproduction module reproduces the variable moving picture stored in a CD or hard disk drive (HDD) of the user computer. Further, there is another way that the variable moving picture reproduction module receives the variable moving picture through the Internet to reproduce the received variable moving picture.

Where the variable moving picture reproduction module receives the variable moving picture through the Internet to reproduce the received variable moving picture, it receives the variable moving picture or its access information from the server at the above S310. The access information represents link information linked to the variable moving picture stored in the server described above.

Where the variable moving picture reproduction module receives the access information for the variable moving picture, the variable moving picture reproduction module receives the variable moving picture linked to the access information from the server at the above step S310. Then, the variable moving picture reproduction module separates respective partial moving pictures and their reproduction information from the variable moving picture at the above step S320. In other words, at the above step S320, the variable moving picture reproduction module separates the respective partial moving pictures and their reproduction information from the variable moving picture synthesized at the above steps S150 of FIG. 1 and S240 of FIG. 3.

At the first reproduction step S330, the variable moving picture reproduction module reproduces a first partial moving picture on the basis of reproduction information separated at the above step S320, wherein the first partial moving picture represents a partial moving picture to be first transmitted. The reproduction information separated at the above step S320 includes setting information for the first partial moving picture. The first partial moving picture is reproduced on the basis of the reproduction information at the first reproduction step S330.

Because moving picture reproduction techniques relating to the present invention are well known to those in the art and publicly used, the description of the moving picture reproduction is omitted.

Where information relating to the user's action is inputted from the user at the above step S340, the variable moving picture reproduction module determines from the reproduction information whether there is a partial moving picture corresponding to the user's action.

The respective partial moving pictures contained in the variable moving picture are reproduced on the basis of reproduction conditions. The reproduction conditions are set through a prediction of the user's actions for the variable moving picture.

Accordingly, the user reproducing the variable moving picture can take the action such as uttering a voice or selects a predetermined portion of a display screen using a mouse. At this time, the variable moving picture reproduction module determines whether information relating to the user's action inputted corresponds to a reproduction condition of each partial moving picture.

If there is the partial moving picture corresponding to the user's action at the above step S340, the variable moving picture reproduction module reproduces the partial moving picture at the second reproduction step S350.

In other words, if there is the partial moving picture meeting the reproduction condition corresponding to the user's action, the variable moving picture reproduction module reproduces the partial moving picture at the second reproduction step S350.

Because moving picture reproduction techniques relating to the above description are well known to those in the art and publicly used, the description of the moving picture reproduction is omitted.

The moving pictures are differently reproduced in response to the user's actions. Therefore, the user can feel the sense of the real from such moving pictures and that such moving pictures can arouse the interest of the user.

Additionally, the variable moving picture reproduction module further separates contents and their synthesis information from respective partial moving pictures at the above step S320. Where a corresponding partial moving picture is reproduced at the above steps S330 and S350, the variable moving picture reproduction module synthesizes the contents corresponding to the partial moving pictures on the basis of the content synthesis information and reproduces the synthesized contents.

The contents include at least one of a partial sound, a partial scent, a partial text, a partial graphic, etc. When the variable moving picture is reproduced in response to the user's actions, the partial moving picture along with a particular sound, a particular scent, a particular message and a particular graphic can be simultaneously reproduced.

Accordingly, in a method for processing moving pictures in response to the user's actions, the variable moving picture creation module creates the variable moving picture to be created differently in response to the user's actions. The variable moving picture reproduction module reproduces the variable moving picture so that the variable moving picture is realistically reproduced. The variable moving picture transmission module transmits the variable moving picture to a receiver's E-mail server, personal data assistant (PDA), mobile communication terminal, computer or etc. over the Internet so that the variable moving picture is reproduced in response to the actions of the user being a receiver. Accordingly, an idea and intention of a transmitting user can be implemented in an enjoyable and interesting manner.

A method for processing moving pictures in response to a user's actions in accordance with an embodiment of the present invention will be described in more detail.

For example, it is assumed that a variable moving picture of a birthday cake is transmitted to a recipient through the E-mail.

A transmission side user accesses a server providing the variable moving picture and selects a desired cake. The variable moving picture of the selected cake is transmitted to the lover.

The variable moving picture is divided into a plurality of partial moving pictures. For convenience, it is assumed that the partial moving pictures include a first partial moving picture of the cake having lit candles, a second partial moving picture of the cake having flickering candles and a third partial moving picture of the cake having blown-out candles.

When the transmission side user sets reproduction information as reproduction conditions, the reproduction information is set so that the first partial moving picture is first reproduced. When a predetermined sound, e.g., a “puff” is inputted into a sound reception unit such as a microphone coupled to a receiver's computer, the reproduction information is set so that the second partial moving picture and a predetermined birthday music are reproduced. Then, the reproduction information is set so that the third partial moving picture can be reproduced until the user selects an end button.

The transmission side user can synthesize various contents such as birthday-congratulation sentences, flowers, graphics, etc. and set content synthesis information.

In response to the transmission side user's setting, the server creates a final variable moving picture to be transmitted to the recipient. Then, the transmission side user transmits the final variable moving picture by attaching it to the E-mail or sending a text including access information linked to the variable moving picture through the E-mail.

The user receiving the E-mail reproduces the variable moving picture by executing the file attached to the E-mail or receiving the variable moving picture from the server after accessing the server using the access information contained in the E-mail.

The first partial moving picture of the cake having the lit candles is first reproduced. When the user puffs out the candles, the second partial moving picture and the birthday music are simultaneously reproduced. Then, the third partial moving picture can be reproduced until the user selects the end button.

Accordingly, the above and other objects of the present invention can be accomplished by the provision of a method for processing moving pictures in response to a user's actions.

Industrial Applicability

As apparent from the above description, the present invention provides a method for processing moving pictures in response to a user's actions. In the method in accordance with the present invention, a variable moving picture creation module creates a variable moving picture to be created differently in response to the user's actions. The variable moving picture reproduction module reproduces the variable moving picture so that the variable moving picture is realistically reproduced. A variable moving picture transmission module transmits the variable moving picture to a receiver's E-mail server, personal data assistant (PDA), mobile communication terminal, computer or etc. over the Internet so that the variable moving picture is reproduced in response to the action of the user being a receiver. Accordingly, an idea and intention of a transmitting user can be implemented in an enjoyable and interesting manner.

Although the present invention has been described in connection with specific preferred embodiments, those skilled in the art will appreciate that various modifications, additions, and substitutions to the specific elements are possible, without departing from the scope and spirit of the present invention as disclosed in the accompanying claims.

1. A method for processing moving pictures in response to a user's actions, comprising the steps of:
a) allowing a variable moving picture creation module to analyze predicted actions of a receiver receiving the moving pictures;
b) allowing the variable moving picture creation module to create a plurality of partial moving pictures corresponding to types of the predicted actions analyzed at the step a);
c) allowing the variable moving picture creation module to set reproduction information of respective partial moving pictures created at the step b); and
d) allowing the variable moving picture creation module to create a variable moving picture by combining the partial moving pictures created at the step b) and the reproduction information created at the step c).

2. The method as set forth in claim 1, further comprising the step of:
e) allowing the variable moving picture creation module to set predetermined content synthesis information with respect to the respective partial moving pictures created at the step b); and
f) allowing the variable moving picture creation module to create another variable moving picture having the content synthesis information by further combining the content synthesis information with the variable moving picture.

3. The method as set forth in claim 2, wherein the contents include at least one of a partial sound, a partial scent, a partial text and a partial graphic.

4. The method as set forth in any one of claims 1 to 3, wherein the reproduction information set at the step c) includes setting information relating to a partial moving picture to be first produced.

5. The method as set forth in claim 4, wherein the step c) includes the step of setting the production information so that the respective partial moving pictures are selectively produced in response to a receiver's action.

6. The method as set forth in claim 5, wherein the respective partial moving pictures are real moving pictures captured by moving capturing means.

7. The method as set forth in claim 5, wherein the respective partial moving pictures have a part of real moving pictures captured by moving capturing means and another real moving picture synthesized with it.

8. The method as set forth in claim 5, wherein the respective partial moving pictures have a part of real moving pictures captured by moving capturing means and a graphic synthesized with it.

9. A method for processing moving pictures in response to a user's actions, comprising the steps of:
a) allowing a variable moving picture transmission module to receive selection information of a variable moving picture from a client terminal connected to a network;
b) allowing the variable moving picture transmission module to receive selection information of contents to be synthesized with respective partial moving pictures of the variable moving picture selected at the step a);
c) allowing the variable moving picture transmission module to synthesize the partial moving pictures of the variable moving picture with the contents selected at the step b); and
d) allowing the variable moving picture transmission module to transmit the partial moving pictures synthesized at the step c) or their access information to a receiver's terminal.

10. The method as set forth in claim 9, further comprising the step of:
e) allowing the variable moving picture transmission module to receive variable moving picture receiver information.

11. The method as set forth in claim 10, wherein the variable moving picture receiver information includes a receiver's E-mail address, the receiver's PDA Internet protocol (IP) address, a mobile IP address of the receiver's mobile communication terminal and an IP address of the receiver's computer.

12. The method as set forth in any one of claims 9 to 11, wherein the contents include at least one of a partial sound, a partial scent, a partial text and a partial graphic.

13. The method as set forth in claim any one of claims 9 to 11, wherein the step d) includes the step of
transmitting the access information linked to the variable moving picture to the receiver's terminal in response to a receiver's terminal request where the access information for the partial moving pictures synthesized is transmitted.

14. The method as set forth in claim 12, wherein the step d) includes the step of transmitting the access information linked to the variable moving picture to the receiver's terminal in response to a receiver's terminal request where the access information for the partial moving pictures synthesized is transmitted.

15. A method for processing moving pictures in response to a user's actions, comprising the steps of:
a) allowing a variable moving picture reproduction module to separate respective partial moving pictures and reproduction information from a variable moving picture;
b) allowing the variable moving picture reproduction module to reproduce a first partial moving picture on the basis of the reproduction information separated at the step a);
c) allowing the variable moving picture reproduction module to determine using the reproduction information whether there is a second partial moving picture corresponding to a predetermined action when the predetermined action has been taken by the user; and
d) allowing the variable moving picture reproduction module to reproduce the second partial moving picture if there is the second partial moving picture corresponding to the predetermined action at the step c).

16. The method as set forth in claim 15, further comprising the step of:
e) allowing the variable moving picture reproduction module to receive the variable moving picture or its access information from a server.

17. The method as set forth in claim 16, wherein the step e) includes the step of receiving the variable moving picture linked to the access information from the server when the access information linked to the variable moving picture is received.

18. The method as set forth in any one of claims 15 to 17, wherein the step a) includes the step of separating contents synthesized with the partial moving pictures and content synthesis information from the variable moving picture; and the steps b) and d) include the step of synthesizing and reproducing the contents corresponding to the partial moving picture on the basis of the content synthesis information when the partial moving picture is reproduced.

19. The method as set forth in any one of claims 15 to 17, wherein the contents include at least one of a partial sound, a partial scent, a partial text and a partial graphic.

20. The method as set forth in claim 18, wherein the contents include at least one of a partial sound, a partial scent, a partial text and a partial graphic.
